(19) United States
(12) Patent Application Publication
(10) Pub. No.: US 2025/0219266 A1
(43) Pub. Date: Jul. 3, 2025

(54) SECONDARY BATTERY AND ELECTRONIC APPARATUS

(71) Applicant: Ningde Amperex Technology Limited, Ningde (CN)

(72) Inventor: Lisha WANG, Ningde (CN)

(73) Assignee: Ningde Amperex Technology Limited, Ningde (CN)

(21) Appl. No.: 19/003,133

(22) Filed: Dec. 27, 2024

(30) Foreign Application Priority Data
Dec. 29, 2023 (CN) 202311873112.3

(51) Int. Cl. H01M 50/562; C09J 7/35; H01M 10/0525; H01M 10/0569; H01M 50/105; H01M 50/178; H01M 50/186; H01M 50/193; H01M 50/553

(52) U.S. Cl. CPC H01M 50/562; C09J 7/35; H01M 10/0525; H01M 10/0569; H01M 50/105; H01M 50/178; H01M 50/186; H01M 50/193; H01M 50/553; C09J 2203/33; C09J 2301/304; H01M 2300/0034; H01M 2300/0042

(57) ABSTRACT

A secondary battery includes a packaging bag, an electrode assembly, a tab, a tab adhesive, and an adhesive member. The electrode assembly includes a first surface, and the tab protrudes from the electrode assembly through the first surface. The tab extends in direction Y, a thickness direction of the tab is direction Z, and a direction perpendicular to the directions Y and Z is direction X. A thickness of the tab is H₁ μm, where 80≤H₁≤100. The tab is covered with the tab adhesive, the tab adhesive is adhered to the packaging bag, and a DSC curve of the tab adhesive has an endothermic peak at a temperature T° C., where 135≤T≤165. The tab includes a positive electrode tab and a negative electrode tab, and the adhesive member is disposed between the positive and negative electrode tabs in the direction X.

### CROSS-REFERENCE TO RELATED APPLICATION

The present application claims priority to Chinese Patent application No. CN 202311873112.3 filed in the China National Intellectual Property Administration on Dec. 29, 2023, the entire content of which is hereby incorporated by reference.

### TECHNICAL FIELD

This application relates to the field of electrochemical technologies, and in particular, to a secondary battery and an electronic apparatus.

### BACKGROUND

Secondary batteries such as lithium-ion batteries have advantages such as high energy storage density, high open-circuit voltage, low self-discharge rate, long cycle life, and high safety, and therefore have been widely used in the fields such as portable electrical energy storage, electronic devices, and electric vehicles.

To enhance the fast charging performance of lithium-ion batteries, the internal resistance of lithium-ion batteries is becoming smaller and smaller, and thousands of amps of current can be generated during an external short circuit, posing a great safety hazard. When a lithium-ion battery experiences an external short circuit, the current is very large, and heat is generated inside the battery rapidly, greatly increasing the risk of thermal runaway of the lithium-ion battery.

### SUMMARY

The inventor has found that increasing the thickness of a tab can improve the current flowing capability of the tab and reduce the temperature rise of the tab to alleviate the thermal runaway problem caused by external short circuit of the secondary battery. In addition, to ensure the effectiveness of packaging, the thickness of a tab adhesive also needs to be increased correspondingly. However, under high-temperature conditions, such as during a hot box test, a commonly used tab adhesive cannot melt due to low heat generation and temperature rise of the tab, and a release channel for the gas and heat inside the secondary battery cannot be formed, leading to thermal runaway of the secondary battery. The inventor has found that this problem can be alleviated by lowering the melting point of the tab adhesive. However, a tab adhesive with a low melting point may melt during an external short circuit, and a tab with a high temperature may lead to the melting of the sealing layer of the packaging bag, resulting in the conduction of the tab with the metal layer of the packaging bag and exacerbating the risk of short circuit so that the thermal runaway problem caused by external short circuit of the secondary battery still cannot be alleviated. Therefore, how to balance the alleviation of external short circuit and hot box test problems to enhance the safety performance of lithium-ion batteries has become an urgent problem to be solved.

An objective of this application is to provide a secondary battery and an electronic apparatus, to improve safety performance of secondary batteries. Specific technical solutions are as follows.

A first aspect of this application provides a secondary battery including a packaging bag, an electrode assembly, a tab, a tab adhesive, and an adhesive member. The electrode assembly is accommodated in the packaging bag. The electrode assembly includes a first surface, and the tab protrudes from the electrode assembly through the first surface. The tab extends in direction Y, a thickness direction of the tab is direction Z, and a direction perpendicular to the direction Y and the direction Z is direction X. A thickness of the tab is H₁ μm, where 80≤H₁≤100. The tab is covered with the tab adhesive, the tab adhesive is adhered to the packaging bag, and a DSC curve of the tab adhesive has an endothermic peak at a temperature of T° C., where 135≤T≤165. The tab includes a positive electrode tab and a negative electrode tab, and the adhesive member is disposed between the positive electrode tab and the negative electrode tab in the direction X. The adhesive member includes a first adhesive layer, a substrate layer, and a second adhesive layer stacked together and is adhered to the first surface through the first adhesive layer. The second adhesive layer is a thermosensitive adhesive layer. With the adhesive member being disposed between the positive electrode tab and the negative electrode tab and values of H₁ and T being controlled with the foregoing ranges, the internal resistance of the secondary battery can be lowered, the heat generated by the tab can be reduced, and the risk of thermal runaway can be reduced when external short circuit of the secondary battery occurs. In addition, when the temperature reaches the range of 135° C. to 165° C., the tab adhesive is prone to melting, and a release channel for the gas and heat inside the secondary battery can be formed, reducing the risk of thermal runaway of the secondary battery. Moreover, as the temperature rises to the foregoing range, the second adhesive layer can be adhered to the packaging bag, and the gas inside the secondary battery accumulates at the tab and two sides to the tab so that the air pressure borne by the tab and two sides to the tab is high, facilitating to rupture the packaging bag. This can reduce the possibilities of gas swelling deformation and separator shrinkage in the secondary battery, thereby reducing the risk of internal short circuit of the secondary battery and improving the safety performance of the secondary battery. In addition, with the adhesive member being disposed between the positive electrode tab and the negative electrode tab, the risks of inferior infiltration of the electrolyte to the negative electrode plate and lithium precipitation can be reduced, and this is conducive to improving the cycling performance of the secondary battery.

In some embodiments of this application, in the direction X, a dimension of the electrode assembly is B mm, in the direction Y, a dimension of the electrode assembly is A mm, and in the direction Z, a dimension of the electrode assembly is E mm, and in the direction X, a width of the adhesive member is C mm, 0.0014×T×B≤C≤0.004×T×B; and in the direction Z, the electrode assembly includes a second surface and a third surface opposite to each other, the adhesive member extends from second surface to the third surface, and a sum of dimensions of the adhesive member affixed within the first surface, the second surface, and the third surface is a length of the adhesive member, and the length of the adhesive member is D mm, where E+0.25 A≤D≤E+0.28 A. With T, B, and C, and E, A, and D being controlled to satisfy the foregoing relationships, the risks of inferior infiltration of the electrolyte to the negative electrode plate can be reduced, and this is conducive to improving the cycling performance of the secondary battery. Moreover, this is conducive to reducing the possibilities of gas swelling deformation and separator shrinkage in the secondary battery, thereby alleviating the problem of internal short circuit of the secondary battery and further enhancing the safety performance of the secondary battery.

In some embodiments of this application, 70≤A≤100, 40≤B≤70, and 4≤E≤6. With the adhesive member being disposed between the positive electrode tab and the negative electrode tab and values of A, B, and E being controlled within the foregoing range, the function of the adhesive member can be better exerted, and this is conducive to reducing the possibilities of gas swelling deformation and separator shrinkage in the secondary battery, thereby reducing the risk of internal short circuit of the secondary battery and better improving the safety performance of the secondary battery.

In some embodiments of this application, a sum of the dimensions of the adhesive member affixed within the second surface and the third surface is L mm, where 0.25 A≤L≤0.28 A. With L and A being controlled to satisfy the foregoing relationship, the structure of the secondary battery can be more stable, and the function of the adhesive member can be better exerted, and this is more conducive to reducing the possibility of gas swelling deformation and separator shrinkage in the secondary battery, thereby reducing the risk of internal short circuit of the secondary battery and improving the safety performance of the secondary battery.

In some embodiments of this application, 17.5≤L≤30. With the value of L being controlled within the foregoing range, the structure of the secondary battery can be more stable, the function of the adhesive member can be better exerted, and this is more conducive to reducing the possibilities of gas swelling deformation and separator shrinkage of the secondary battery, thereby reduce the risk of internal short circuit of the secondary battery and further improve the safety performance of the secondary battery.

In some embodiments of this application, in the direction X, a dimension of the tab adhesive extending beyond the tab is a shoulder width of the tab adhesive, the shoulder width of the tab adhesive is M mm, and in the direction X, a distance between the tab adhesive and the adhesive member is N mm, where 0.25M≤N≤0.5M. With N and M being controlled to satisfy the foregoing relationship, the gas inside the secondary battery can accumulate at the tab and two sides to the tab so that the tab and two sides to the tab bear higher air pressure, more likely to result in the melting of the tab adhesive to form a release channel for the gas and heat inside the secondary battery, and this can reduce the possibilities of gas swelling deformation and separator shrinkage in the secondary battery, thereby alleviating the problem of internal short circuit of the secondary battery and further enhancing the safety performance of the secondary battery. In addition, controlling N and M to satisfy the foregoing relationship is conducive to further reducing the risk of inferior infiltration of the electrolyte to the negative electrode plate and lithium precipitation and improving the cycling performance of the secondary battery.

In some embodiments of this application, 1.2≤M≤2.3. With the value of M being controlled within the foregoing range, the tab adhesive can maintain a stable structure during the use of the secondary battery, thereby enhancing the safety performance of the secondary battery.

In some embodiments of this application, a material of the first adhesive layer includes at least one of polyethylene oxide, acrylonitrile-styrene-butadiene copolymer, styrene-butadiene copolymer, polyvinyl alcohol, polyvinyl methyl ether, polyvinyl ethyl ether, polyvinylidene difluoride, polytetrafluoroethylene, polyhexafluoropropylene, polyacrylic acid, polymethyl methacrylate, polypropylene, polyethylene, or polyamide; a material of the second adhesive layer (thermosensitive adhesive layer) includes at least one of polymethyl methacrylate, polyacrylic acid, polyacrylate, polyacrylonitrile, polyvinylpyrrolidone, ethylene vinyl acetate copolymer, styrene-isoprene-styrene block copolymer, ethylene-vinyl acetate copolymer, or polyimide; and a material of the substrate layer includes at least one of polyethylene, polypropylene, polyethylene terephthalate, or polyimide. With the use of the materials for the first adhesive layer and of the materials for the second adhesive layer (thermosensitive adhesive layer), this is conducive to exert the function of the adhesive member, alleviating the problem of internal short circuit of the secondary battery, and enhancing the safety performance of the secondary battery.

In some embodiments of this application, the thickness of the tab adhesive is H₂ μm, where 100≤H₂≤200. With the value of H₂ being controlled within the foregoing range, the in tab adhesive can exert the protective function at the root of the tab, and it also facilitates the melting of the tab adhesive at high temperatures, allowing the tab and two sides to the tab to be ruptured to form a release channel for the gas and heat inside the secondary battery. This reduces the risk of internal short circuit of the secondary battery and enhances the safety performance of the secondary battery.

In some embodiments of this application, the tab adhesive on the surface of tab includes a first adhesive layer, a second adhesive layer, and a third adhesive layer stacked together, a melting point of the first adhesive layer is T₁° C., a melting point of the second adhesive layer is T₂° C., and a melting point of the third adhesive layer is T₃° C., where 120≤T₁≤125, 135≤T₂≤165, and 120≤T₃≤125. With T₁, T₂, and T₃ being controlled to satisfy the foregoing relationships, it is more conducive to exerting the protective function of the tab adhesive at the root of the tab, and it is also conducive to facilitating the melting of the tab adhesive at high temperatures, allowing the tab and two sides to the tab to be ruptured to form a release channel for the gas and heat inside the secondary battery. This further reduces the risk of internal short circuit of the secondary battery, thereby better improving the safety performance of the secondary battery.

In some embodiments of this application, a material of the tab adhesive includes at least one of polypropylene, polyethylene, polyethylene terephthalate, polyimide, polyamide, or polyethylene terephthalate. The use of the foregoing materials for the tab adhesive is conducive to obtaining a tab adhesive exhibiting an endothermic peak at a temperature of T° C. in the DSC curve, with 135≤T≤165, and is conducive to forming a release channel for the gas and heat inside the secondary battery. This reduces the risk of thermal runaway of the secondary battery, alleviates the problem of internal short circuit of the secondary battery, and enhances the safety performance of the secondary battery.

In some embodiments of this application, the packaging bag further includes a sealing layer, the sealing layer is adhered to the tab adhesive, and a material of the sealing layer includes at least one of polypropylene or polyethylene. With the use of the foregoing sealing layer materials and the sealing layer being adhered to the tab adhesive, this is conducive to enhancing the sealing of the packaging bag to the secondary battery and enhancing the safety performance of the secondary battery.

In some embodiments of this application, the secondary battery further includes an electrolyte. The electrolyte includes ethyl propionate, propyl propionate, ethylene carbonate, and fluoroethylene carbonate, and based on a mass of the electrolyte, a mass percentage of ethyl propionate is 8% to 35%, a mass percentage of propyl propionate is 14% to 40%, a mass percentage of ethylene carbonate is 6% to 35%, and a mass percentage of fluoroethylene carbonate is 2% to 5%. The electrolyte with the forgoing compositions provides good chemical stability at normal temperature, and at high temperatures, the amount of gas produced by the electrolyte allows the packaging bag to be ruptured. This reduces the possibility of gas swelling deformation and separator shrinkage in the secondary battery, thereby reducing the risk of internal short circuit of the secondary battery and improving the safety and cycling performance of the secondary battery.

A second aspect of this application provides an electronic apparatus including the secondary battery according to the first aspect of this application. The secondary battery provided in the first aspect of this application has good safety performance and cycling performance, so that the electronic apparatus provided in the second aspect of this application has long service life.

This application has the following beneficial effects:

This application provides a secondary battery and an electronic apparatus. The secondary battery includes a packaging bag, an electrode assembly, a tab, a tab adhesive, and an adhesive member. The electrode assembly is accommodated within the packaging bag. The electrode assembly includes a first surface, and the tab is provided protruding from the electrode assembly through the first surface. The tab extends in direction Y, a thickness direction of the tab is direction Z, a direction perpendicular to the direction Y and the direction Z is direction X. A thickness of the tab is H₁ μm, where 80≤H₁≤100. The tab is covered with the tab adhesive, the tab adhesive is adhered to the packaging bag, and a DSC curve of the tab adhesive has an endothermic peak at a temperature of T° C., where 135≤T≤165. The tab includes a positive electrode tab and a negative electrode tab, and the adhesive member is disposed between the positive electrode tab and the negative electrode tab in the direction X. The adhesive member includes a first adhesive layer, a substrate layer, and a second adhesive layer stacked together and is adhered to the first surface through the first adhesive layer. The second adhesive layer is a thermosensitive adhesive layer. With the adhesive member being disposed on the first surface and the values of H₁ and T being controlled within the foregoing ranges, the internal resistance of the secondary battery can be lowered, the heat generated by the tab can be reduced, and the risk of thermal runaway can be reduced when external short circuit of the secondary battery occurs. In addition, when the temperature reaches the range of 135° C. to 165° C., the tab adhesive is melted, and a release channel for the gas and heat inside the secondary battery is formed, reducing the risk of thermal runaway of the secondary battery. Moreover, as the temperature rises to the foregoing range, the second adhesive layer can be adhered to the packaging bag, and the gas inside the secondary battery accumulates at the tab and two sides to the tab so that the tab and two sides to the tab bear higher air pressure and are more likely to be ruptured. This thus reduces the risks of gas swelling deformation and separator shrinkage in the secondary battery, thereby reducing the risk of internal short circuit of the secondary battery and improving the safety performance of the secondary battery. In addition, with the adhesive member being disposed between the positive electrode tab and the negative electrode tab, the risks of inferior infiltration of the electrolyte to the negative electrode plate and lithium precipitation can be reduced, and this is conducive to improving the cycling performance of the secondary battery.

Certainly, when any product or method of this application is implemented, all advantages described above are not necessarily demonstrated simultaneously.

### BRIEF DESCRIPTION OF DRAWINGS

To describe the technical solutions in some embodiments of this application or in the prior art more clearly, the following briefly describes the accompanying drawings required for describing these embodiments or the prior art. Apparently, the accompanying drawings in the following descriptions show merely some embodiments of this application, and persons of ordinary skill in the art may still derive other embodiments from these accompanying drawings.

FIG. 1 is a schematic diagram of an affixing position of an adhesive member according to an embodiment of this application;

FIG. 2 is a schematic structural diagram of an adhesive member from the perspective of direction Z according to an embodiment of this application;

FIG. 3 is a schematic diagram of an affixing position of an adhesive member on a first surface from the perspective of direction Y according to an embodiment of this application;

FIG. 4 is a schematic diagram of an affixing position of an adhesive member on a second surface from the perspective of direction Z according to an embodiment of this application;

FIG. 5 is a schematic diagram of an affixing position of the adhesive member on a third surface opposite to FIG. 4;

FIG. 6 is a schematic diagram of an affixing position of an adhesive member of Comparative example 2 on a first surface from the perspective of direction Y; and

FIG. 7 is a DSC curve of a tab adhesive of Example 1-5.

Reference signs: secondary battery 100, electrode assembly 10, tab 20, adhesive member 30, tab adhesive 40, first surface 10a, second surface 10b, third surface 10c, positive electrode tab 21, negative electrode tab 22, positive electrode tab adhesive 40a, negative electrode tab adhesive 40b, first adhesive layer 31, substrate layer 32, and second adhesive layer 33.

### DESCRIPTION OF EMBODIMENTS

The following clearly and completely describes the technical solutions in embodiments of this application with reference to the accompanying drawings in the embodiments of this application. Apparently, the described embodiments are only some rather than all of these embodiments of this application. All other embodiments obtained by persons skilled in the art based on this application shall fall within the protection scope of this application.

It should be noted that in the following content, an example in which a lithium-ion battery is used as a secondary battery is used to illustrate this application. However, the secondary battery of this application is not limited to the lithium-ion battery.

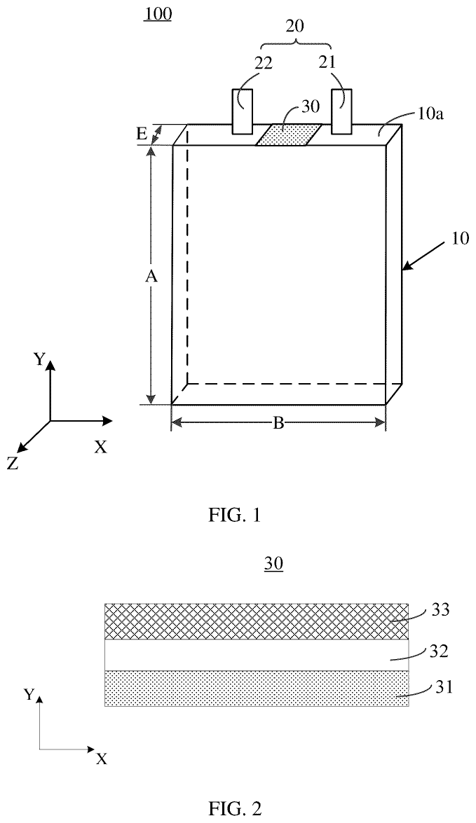

A first aspect of this application provides a secondary battery. As shown in FIG. 1, the secondary battery 100 includes a packaging bag (not shown in FIG. 1), an electrode assembly 10, a tab 20, a tab adhesive (not shown in FIG. 1), and an adhesive member 30. The electrode assembly 10 is accommodated in the packaging bag. The electrode assembly 10 includes a first surface 10a, and the tab 20 protrudes from electrode assembly 10 through first surface 10a. The tab 20 extends in direction Y, a thickness direction of the tab 20 is direction Z, and a direction perpendicular to the direction Y and the direction Z is direction X. A three-dimensional direct coordinate system is established with the directions X, Y, and Z. The tab 20 includes a positive electrode tab 21 and a negative electrode tab 22. In direction X, the adhesive member 30 is disposed between the positive electrode tab 21 and the negative electrode tab 22 and adhered to the first surface 10a. As shown in FIG. 2, the adhesive member 30 includes a first adhesive layer 31, a substrate layer 32, and a second adhesive layer 33 stacked together, with the second adhesive layer 33 being a thermosensitive adhesive layer. The adhesive member 30 is adhered to the first surface 10a through the first adhesive layer 31. The thickness of the tab is H₁ μm, where 80≤H₁≤100. For example, a value of H₁ may be 80, 83, 85, 87, 90, 92, 95, 97, or 100, or a range defined by any two of the foregoing values. The tab 20 is covered with a tab adhesive (not shown in FIG. 1). The tab adhesive is adhered to the packaging bag, and a DSC curve of the tab adhesive includes an endothermic peak at a temperature of T° C., where 135≤T≤165. For example, a value of T may be 135, 138, 140, 148, 150, 153, 155, 157, 160, or 165, or a range defined by any two of the foregoing values.

The inventor has found that when H₁ is too small, for example, less than 80 μm, the tab is not only prone to deformation and fracture, but also causes the internal resistance of the secondary battery to be too large, increasing heat generation and power loss, thereby affecting the chemical reaction rate, electrolyte stability, and service life of the battery, and even causing safety risks such as thermal runaway, combustion, or explosion; and that when H₁ is too large, for example, greater than 100 μm, although the tab can reduce the internal resistance of the secondary battery, the low temperature rise of the tab adhesive prevents the tab adhesive from melting, and a release channel for the gas and heat inside the secondary battery cannot be formed, leading to thermal runaway of the secondary battery and affecting the safety performance of the secondary battery. When the internal temperature of the battery rises to around 130° C., the risk of thermal runaway increases significantly. When T is too large, for example, greater than 165° C., the tab adhesive still cannot melt, and a release channel for the gas and heat inside the secondary battery cannot be formed, leading to thermal runaway of the secondary battery. When T is too small, for example, less than 135° C., the tab adhesive melts at a low temperature, increasing the risk of thermal runaway and combustion of the secondary battery and affecting the performance and safety of the battery. The provision of the adhesive member on two sides of the positive electrode tab and negative electrode tab may cause inferior infiltration of the electrolyte to the negative electrode plate, especially in the corner regions of the wound structure of the secondary battery, thereby affecting the cycling performance of the secondary battery. With the adhesive member being disposed between the positive electrode tab and the negative electrode tab and values of H₁ and T being controlled with the foregoing ranges, the internal resistance of the secondary battery can be lowered, the heat generated by the tab can be reduced, and the risk of thermal runaway can be reduced when external short circuit of the secondary battery occurs. In addition, when the temperature reaches the range of 135° C. to 165° C., the tab adhesive melts, and a release channel for the gas and heat inside the secondary battery is formed, reducing the risk of thermal runaway of the secondary battery. Moreover, as the temperature rises to the foregoing range, the second adhesive layer can be adhered to the packaging bag, and the gas inside the secondary battery accumulates at the tab and two sides to the tab so that the air pressure borne by the tab and two sides to the tab is high, facilitating to rupture the packaging bag. This can reduce the possibilities of gas swelling deformation and separator shrinkage in the secondary battery, thereby reducing the risk of internal short circuit of the secondary battery and improving the safety performance of the secondary battery. In addition, with the adhesive member being disposed between the positive electrode tab and the negative electrode tab, the risks of inferior infiltration of the electrolyte to the negative electrode plate and lithium precipitation can be reduced, and this is conducive to improving the cycling performance of the secondary battery.

For a single-tab structure, one adhesive member is disposed between the positive electrode tab and the negative electrode tab, and for a multi-tab structure, the adhesive member can be disposed between each set of positive electrode tab and negative electrode tab. The number of adhesive members is not particularly limited in this application and can be selected according to actual needs, provided that the objectives of this application can be achieved. In addition, for a multi-tab structure, the tab includes a die-cut tab and an adapter tab, and the tab adhesive is applied to the adapter tab.

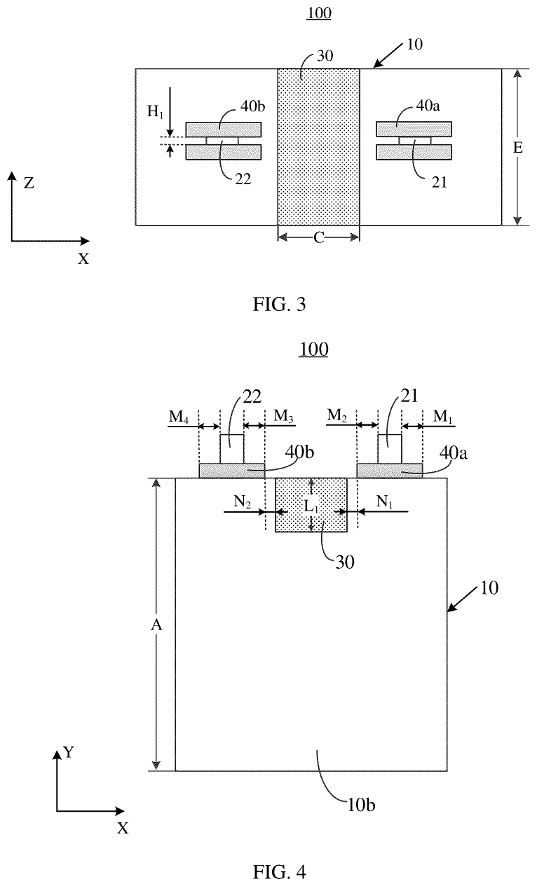

In some embodiments of this application, as shown in FIG. 1, in the direction X, a dimension of the electrode assembly is B mm, in the direction Y, a dimension of the electrode assembly is A mm, and in the direction Z, a dimension of the electrode assembly is E mm. As shown in FIG. 3, in the direction X, a width of the adhesive member is C mm, 0.0014×T×B≤C≤0.004×T×B. For example, C may be 0.0014×T×B, 0.0016×T×B, 0.002×T×B, 0.0025×T×B, 0.003×T×B, 0.0035×T×B, or 0.004×T×B, or a range defined by any two of the foregoing values. With T, B, and C being controlled to satisfy the foregoing relationship, the risk of inferior infiltration of the electrolyte to the negative electrode plate can be reduced, and this is conducive to improving the cycling performance of the secondary battery. Moreover, this is conducive to reducing the possibilities of gas swelling deformation and separator shrinkage in the secondary battery, thereby alleviating the problem of internal short circuit of the secondary battery and further enhancing the safety performance of the secondary battery.

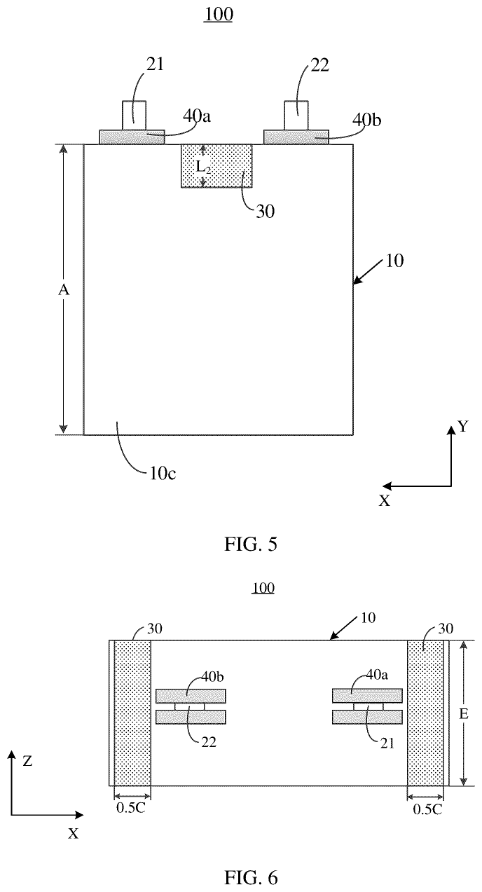

FIG. 3 is a schematic diagram of an affixing position of an adhesive member on a first surface from the perspective of direction Y according to an embodiment of this application. The adhesive member 30 is affixed to the first surface 10a, and in the direction Z, the dimension of the adhesive member 30 affixed within the first surface 10a is E mm. In the direction Z, the electrode assembly 10 includes a second surface 10b and a third surface 10c opposite to each other. Optionally, the adhesive member 30 extends from the second surface 10b to the third surface 10c, and a sum of dimensions of the adhesive member 30 affixed within the first surface 10a, the second surface 10b, and the third surface 10c is a length of the adhesive member, and the length of the adhesive member is D mm. FIG. 4 is a schematic structural diagram of an affixing position of an of adhesive member on a second surface from the perspective of direction Z according to an embodiment of this application; and FIG. 5 is a schematic structural diagram of an affixing position of the adhesive member on a third surface opposite to FIG. 4. As shown in FIG. 4, the dimension of the adhesive member 30 affixed within the second surface 10b is L₁ mm. As shown in FIG. 5, the dimension of the adhesive member 30 affixed within the third surface 10c is L₂ mm. In some embodiments, when the adhesive member is only affixed within the first surface 10a, the length D of the adhesive member equals the dimension E of the electrode assembly in the direction Z, that is, D=E. In some other embodiments, the adhesive member 30 extends from the second surface 10b to the third surface 10c through the first surface 10a, then the length of the adhesive member D=E+L₁+L₂, where E+0.25 A≤D≤E+0.28 A. For example, a value of D may be E+0.25 A, E+0.26 A, E+0.265 A, E+0.27 A, or E+0.28 A, or a range defined by any two of the foregoing values. With E, A, and D being controlled to satisfy the foregoing relationship, the risk of inferior infiltration of the electrolyte to the negative electrode plate can be reduced, and it is also conducive to further reducing the possibility of gas swelling deformation and separator shrinkage in the secondary battery, thereby alleviating the problem of internal short circuit of the secondary battery and further enhancing the safety performance of the secondary battery.

In some embodiments of this application, 70≤A≤100, 40≤B≤70, and 4≤E≤6. For example, a value of A may be 70, 73, 75, 77, 80, 82, 85, 87, 90, 92, 95, 98, or 100, or a range defined by any two of the foregoing values; a value of B may be 40, 43, 45, 58, 50, 53, 55, 58, 60, 62, 65, 68, or 70, or a range defined by any two of the foregoing values; and a value of E may be 4, 4.3, 4.5, 4.8, 5, 5.2, 5.5, 5.8, or 6, or a range defined by any two of the foregoing values. With the adhesive member being disposed between the positive electrode tab and the negative electrode tab and values of A, B, and E being controlled within the foregoing range, the adhesive member and the electrode assembly are optimally positioned relative to each other, so that the function of the adhesive member can be better exerted, and this is conducive to reducing the possibilities of gas swelling deformation and separator shrinkage in the secondary battery, thereby reducing the risk of internal short circuit of the secondary battery and better improving the safety performance of the secondary battery.

In some embodiments of this application, as shown in FIG. 4 and FIG. 5, in the direction Z, the electrode assembly 10 includes a second surface 10b and a third surface 10c opposite to each other, and the adhesive member 30 extends from the second surface 10b to the third surface 10c. In the direction Y, a dimension of the electrode assembly 10 is A mm, and a sum of dimensions of the adhesive member 30 affixed within the second surface 10b and the third surface 10c is L mm. As shown in FIG. 4, a dimension of the adhesive member 30 affixed within the second surface 10b is L₁ mm. As shown in FIG. 5, a dimension of the adhesive member 30 affixed within the third surface 10c is L₂ mm, and a sum of dimensions of the adhesive member affixed within the second surface and the third surface is L=L₁+L₂, where L is in the range of 0.25 A≤L≤0.28 A. For example, L may be 0.25 A, 0.26 A, 0.265 A, 0.27 A, or 0.28 A, or a range defined by any two of the foregoing values. With L and A being controlled to satisfy the foregoing relationship, this is conducive to achieving the functions of insulation protection, fixed connection, and heat management of the adhesive member, the structure of the secondary battery can be more stable, and the function of the adhesive member can be better exerted, and this is more conducive to reducing the possibility of gas swelling deformation and separator shrinkage in the secondary battery, thereby reducing the risk of internal short circuit of the secondary battery and improving the safety performance of the secondary battery.

In some embodiments of this application, 17.5≤L≤30. For example, a value of L may be 17.5, 19, 20, 22, 25, 27, or 30, or a range defined by any two of the foregoing values. With the value of L being controlled within the foregoing range, the structure of the secondary battery can be more stable, the function of the adhesive member can be better exerted, and this is more conducive to reducing the possibilities of gas swelling deformation and separator shrinkage of the secondary battery, thereby reduce the risk of internal short circuit of the secondary battery and further improve the safety performance of the secondary battery.

In this application, the width C of the adhesive member may be 6.72 mm to 46.2 mm, and the length D of the adhesive member may be 4 mm to 36 mm. The thickness of the adhesive member in the direction Y is not particularly limited in this application, provided that the objectives of this application can be achieved. For example, the thickness of the adhesive member in the direction Y may be 10 μm to 40 μm.

In some embodiments of this application, in the direction X, a dimension of the tab adhesive extending beyond the tab is a shoulder width of the tab adhesive, and the shoulder width of the tab adhesive is M mm. In the direction X, a distance between the tab adhesive and the adhesive member is N mm, where 0.25M≤N≤0.5M. For example, N may be 0.25M, 0.3M, 0.35M, 0.4M, 0.45M, 0.5M, or a range defined by any two of the foregoing values. With N and M being controlled to satisfy the foregoing relationship, the gas inside the secondary battery can accumulate at the tab and two sides to the tab so that the tab and two sides to the tab bear higher air pressure, more likely to result in the melting of the tab adhesive to form a release channel for the gas and heat inside the secondary battery, and this can reduce the possibilities of gas swelling deformation and separator shrinkage in the secondary battery, thereby alleviating the problem of internal short circuit of the secondary battery and further enhancing the safety performance of the secondary battery. In addition, controlling N and M to satisfy the foregoing relationship is conducive to further reducing the risk of inferior infiltration of the electrolyte to the negative electrode plate and is conducive to improving the cycling performance of the secondary battery.

As shown in FIG. 4, the tab 20 includes a positive electrode tab 21 and a negative electrode tab 22. The tab adhesive 40 includes a positive electrode tab adhesive 40a disposed on the positive electrode tab 21 and a negative electrode tab adhesive 40b disposed on the negative electrode tab 22. In the direction X, the dimension of the tab adhesive 40 is greater than the dimension of the tab 20. Dimensions of the positive electrode tab adhesive 40a extending beyond the positive electrode tab 21 on two sides are M₁ mm and M₂ mm respectively, and dimensions of the negative electrode tab adhesive 40b extending beyond the negative electrode tab 22 on two sides are M₃ mm and M₄ mm respectively. M₁, M₂, M₃, and M₄ may be the same or different. When the four are the same, the shoulder width of the tab adhesive M=M₁=M₂=M₃=M₄. When all four are different, M=(M₁+M 2+M 3+M 4)/4, and this means that M takes the average value of the four. A distance between adjacent edges of the positive electrode tab 21 and the adhesive member 30 extending in the direction Y is N₁ mm, and a distance between adjacent edges of the negative electrode tab 22 and the adhesive member 30 extending in the direction Y is N₂ mm. N₁, N₂ may be the same or different. When the two are the same, the distance between the tab adhesive and the adhesive member N=N₁=N₂. When the two are different, N=(N₁+N₂)/2.

In general, the distance N between the tab adhesive and the adhesive member can be adjusted by adjusting the value of the width C of the adhesive member, the distance between the positive electrode tab and the negative electrode tab, and the shoulder width M of the tab adhesive. When other conditions remain unchanged, as C increases, N decreases; and as C decreases, N increases. When other conditions remain unchanged, as the distance between the positive electrode tab and the negative electrode tab increases, N increases; as the distance between the positive electrode tab and the negative electrode tab decreases, N decreases. When other conditions remain unchanged, as M increases, N decreases; and as M decreases, N increases.

In this application, in the direction Z, the dimension of the tab is the thickness H₁ of the tab and is in the range as described above. The width of the tab in the direction X and the length of the tab in the direction Y is not particularly limited in this application, provided that the objectives of this application can be achieved. For example, the width of the tab in the direction X may be 3 mm to 8 mm, and the length of the tab in the direction Y may be 30 mm to 45 mm.

In some embodiments of this application, 1.2≤M≤2.3. For example, a value of M may be 1.2, 1.3, 1.4, 1.5, 1.6, 1.7, 1.8, 1.9, 2, 2.1, 2.2, or 2.3, or a range defined by any two of the foregoing values. With the value of M being controlled within the foregoing range, the tab adhesive can maintain a stable structure during the use of the secondary battery, and this is conducive to the current transmission in the secondary battery and enhances the stability and safety performance of the secondary battery. In some embodiments, 0.25≤N≤1.15. For example, a value of N may be 0.25, 0.4, 0.5, 0.6, 0.75, 0.9, 1, or 1.15, or a range defined by any two of the foregoing values.

In some embodiments of this application, a material of the first adhesive layer includes at least one of polyethylene oxide, acrylonitrile-styrene-butadiene copolymer, styrene-butadiene copolymer, polyvinyl alcohol, polyvinyl methyl ether, polyvinyl ethyl ether, polyvinylidene difluoride (PVDF), polytetrafluoroethylene (PTFE), polyhexafluoropropylene, polyacrylic acid (PAA), polymethyl methacrylate, polypropylene (PP), polyethylene (PE), or polyamide (PA); a material of the second adhesive layer (thermosensitive adhesive layer) includes at least one of polymethyl methacrylate (PMMA), polyacrylic acid, polyacrylate, polyacrylonitrile, polyvinylpyrrolidone, ethylene vinyl acetate copolymer, styrene-isoprene-styrene block copolymer (SIS), ethylene-vinyl acetate copolymer, or polyimide (PI); and a material of the substrate layer includes at least one of polyethylene, polypropylene, polyethylene terephthalate, or polyimide. With the use of the materials for the first adhesive layer and of the materials for the second adhesive layer (thermosensitive adhesive layer), this is conducive to exert the function of the adhesive member to provide the effects such as fixed connection, insulation protection, resistance to vibration and shock, and auxiliary thermal conductivity, alleviating the problem of internal short circuit of the secondary battery, and enhancing the stability and safety performance of the secondary battery.

In some embodiments of this application, a material of the tab adhesive includes at least one of polypropylene, polyethylene, polyethylene terephthalate, polyimide, polyamide, or polyethylene terephthalate. The use of the foregoing materials for the tab adhesive is conducive to obtaining a tab adhesive exhibiting an endothermic peak at a temperature of T° C. in the DSC curve, with 135≤T≤165, and is conducive to forming a release channel for the gas and heat inside the secondary battery. This reduces the risk of thermal runaway of the secondary battery, alleviates the problem of internal short circuit of the secondary battery, and enhances the safety performance of the secondary battery.

In some embodiments of this application, the packaging bag further includes a sealing layer, the sealing layer is adhered to the tab adhesive, and a material of the sealing layer includes at least one of polypropylene or polyethylene. With the use of the foregoing sealing layer materials and the sealing layer being adhered to the tab adhesive, this is conducive to enhancing the sealing of the packaging bag to the secondary battery and enhancing the safety performance of the secondary battery.

In some embodiments of this application, the thickness of the tab adhesive is H₂ μm, where 100≤H₂≤200. For example, a value of H₂ may be 100, 110, 120, 130, 140, 150, 160, 170, 180, 190, or 200, or a range defined by any two of the foregoing values. In this application, the thickness of the tab adhesive refers to the largest thickness of the tab adhesive, generally the thickness of the tab adhesive at the shoulder width of the tab adhesive. With the value of H₂ being controlled within the foregoing range, the tab adhesive can exert the protective function at the root of the tab, and it also facilitates the melting of the tab adhesive at high temperatures, allowing the tab and two sides to the tab to be ruptured to form a release channel for the gas and heat inside the secondary battery. This reduces the risk of internal short circuit of the secondary battery and enhances the safety performance of the secondary battery.

In some embodiments of this application, the tab adhesive on the surface of tab includes a first adhesive layer, a second adhesive layer, and a third adhesive layer stacked together. A melting point of the first adhesive layer is T₁° C., a melting point of the second adhesive layer is T₂° C., and a melting point of the third adhesive layer is T₃° C., where 120≤T₁≤125, 135≤T₂≤165, and 120≤T₃≤125. For example, a value of T₁ may be 120, 121, 122, 123, 124, or 125, or a range defined by any two of the foregoing values; a value of T₂ may be 135, 148, 150, 153, 155, 157, 160, or 165, or a range defined by any two of the foregoing values; and a value of T₃ may be 120, 121, 122, 123, 124, or 125, or a range defined by any two of the foregoing values. With T₁, T₂, and T₃ being controlled within the foregoing ranges, this is conducive to exerting the protective function of the tab adhesive at the root of the tab to reduce the risk of short circuit at the root of the tab, and it is also conducive to facilitating the melting of the tab adhesive at high temperatures, allowing the tab and two sides to the tab to be ruptured to form a release channel for the gas and heat inside the secondary battery. This further reduces the risk of internal short circuit of the secondary battery, thereby better improving the safety performance of the secondary battery.

In this application, materials used for the first adhesive layer and the third adhesive layer each independently include a first polypropylene; and a weight-average molecular weight Mw₁ of the first polypropylene may be 1000 to 2500. For example, a value of Mw₁ may be 1000, 1500, 2000, 2500, or a range defined by any two of the foregoing values. The material used for the second adhesive layer includes a second polypropylene, and a weight-average molecular weight Mw₂ of the second polypropylene may be 3000 to 5000. For example, a value of Mw₂ may be 3000, 3500, 4000, 4500, 5000, or a range defined by any two of the foregoing values. With the use of the material within the foregoing range for the first adhesive layer and the third adhesive layer, the adhesive function of the tab adhesive can be better exerted, and the generation of bubbles and voids between the tab adhesive and the adhesive surface can also be reduced, reducing the possibility of problems such as peeling and bubble generation during use. With the use of the material within the foregoing range for the second adhesive layer, the tab adhesive can have good high-temperature resistance, adhesion, insulation, and chemical stability, thus better exerting the adhesive function of the tab adhesive and further reducing the risk of internal short circuit of the secondary battery, thereby improving the safety performance of the secondary battery.

In general, the values of T₁ and T₃ can be adjusted by adjusting the weight-average molecular weight Mw₁ of the first polypropylene. As Mw₁ increases, the values of T₁ and T₃ increase; and as Mw₁ decreases, the values of T₁ and T₃ decrease. The value of T₂ can be adjusted by adjusting the weight-average molecular weight Mw₂ of the second polypropylene. As Mw₂ increases, the value of T₂ increases; and as Mw₂ decreases, the value of T₂ decreases.

The first polypropylene and the second polypropylene are not particularly limited in this application, provided that the melting points of the first and third adhesive layers, and the second adhesive layer are within the foregoing ranges. Modification processing on the first polypropylene and the second polypropylene can be performed by those skilled in the art according to actual needs. The modification processing may include but is not limited to addition of a filler or additive, cross-linking treatment, formula optimization, and structural modification. For example, the strength, hardness, heat resistance, and wear resistance of the tab adhesive can be increased by adding a filler such as silica, glass fiber, carbon fiber, or aramid fiber. Alternatively, the process performance and service life of the tab adhesive can be enhanced by adding an additive such as an adhesion promoter, thickener, rheology agent, stabilizer, humectant, or antioxidant. The type of the additive is not particularly limited in this application and can be selected according to actual needs, provided that the objectives of this application can be achieved. Alternatively, the strength, scratch resistance, heat resistance, and chemical corrosion resistance of the tab adhesive can be enhanced by cross-linking treatment, such as thermal cross-linking, ultraviolet cross-linking, or radiation cross-linking. The conditions for the cross-linking treatment are not particularly limited in this application and can be selected according to actual needs, provided that the objectives of this application can be achieved.

In this application, a ratio S of thickness Hₐ of the first adhesive layer, thickness H_{b} of the second adhesive layer, and thickness H_{c} of the third adhesive layer may be 1:(1.2-2):1. For example, S may be 1:1.2:1, 1:1.4:1, 1:1.5:1, 1:1.6:1, 1:1.8:1, or 1:2:1, or a range defined by any two of the foregoing values. The thickness Hₐ of the first adhesive layer, the thickness H_{b} of the second adhesive layer, and the thickness H_{c} of the third adhesive layer refer to the thicknesses of each layer of the tab adhesive measured at the shoulder width of the tab. With the ratio of thickness of the first adhesive layer, the second adhesive layer, and the third adhesive layer being controlled within the foregoing ranges, this is conducive to melting the tab adhesive in a timely manner at high temperatures to form a release channel for the gas and heat inside the secondary battery. In addition, this enables the tab adhesive to exert good adhesive effect while having a small thickness and ensures that the tab adhesive is tightly adhered to the tab and the surface of the electrode assembly, providing a uniform adhesive surface and enhancing the adhesive strength of the tab adhesive. Moreover, this can reduce the generation of bubbles and voids between the tab adhesive and the adhesive surface, reducing the possibility of problems such as peeling and bubble generation during use. Furthermore, this can also reduce costs and improve production efficiency.

In some embodiments of this application, the secondary battery further includes an electrolyte. The electrolyte includes ethyl propionate, propyl propionate, ethylene carbonate, and fluoroethylene carbonate, and based on a mass of the electrolyte, a mass percentage of ethyl propionate is 8% to 35%, a mass percentage of propyl propionate is 14% to 40%, a mass percentage of ethylene carbonate is 6% to 35%, and a mass percentage of fluoroethylene carbonate is 2% to 5%. For example, the mass percentage of ethyl propionate may be 8%, 10%, 15%, 20%, 23%, 25%, 30%, 33%, or 35%, or a range defined by any two of the foregoing values; the mass percentage of propyl propionate may be 14%, 15%, 20%, 23%, 25%, 30%, 33%, 35%, or 40%, or a range defined by any two of the foregoing values; the mass percentage of ethylene carbonate may be 6%, 10%, 15%, 18%, 20%, 23%, 25%, 30%, 33%, or 35%, or a range defined by any two of the foregoing values; and the mass percentage of fluoroethylene carbonate may be 2%, 2.6%, 3%, 3.5%, 4%, 4.7%, or 5%, or a range defined by any two of the foregoing values. The electrolyte with the forgoing compositions provides good chemical stability at normal temperature, and at high temperatures, the side reaction rate of the electrolyte inside the secondary battery accelerates, and the gas production of the electrolyte is faster. The gas produced swells and accumulates more quickly, and the amount of gas produced by the electrolyte allows the packaging bag to be ruptured. This reduces the possibility of gas swelling deformation and separator shrinkage in the secondary battery, thereby reducing the risk of internal short circuit of the secondary battery and improving the safety and cycling performance of the secondary battery.

In this application, the electrolyte further includes a lithium salt. The lithium salt may include at least one of lithium hexafluorophosphate, lithium bis(fluorosulfonyl)imide, lithium bis(trifluoromethylsulfonyl)imide, lithium bis(oxalato)borate, lithium difluoro(oxalato)borate, lithium difluorophosphate, lithium tetrafluoroborate, lithium nitrate, lithium hexafluoroantimonate, lithium hexafluoroarsenate, lithium bis(trifluoromethanesulfonyl)imide, lithium bis(pentafluoroethylsulfonyl)imide, lithium tris(trifluoromethanesulfonyl)methyl, lithium difluoro(oxalato)phosphate, or lithium tetrafluoro(oxalato)phosphate. The mass percentage of the lithium salt is not particularly limited in this application, provided that the objectives of this application can be achieved. For example, based on the mass of the electrolyte, the mass percentage of the lithium salt may be 8% to 20%. For example, the mass percentage of the lithium salt may be 8%, 10%, 12%, 13%, 15%, 18%, or 20%, or a range defined by any two of the foregoing values.

The structure of the electrode assembly is not particularly limited in this application, provided that the objectives of this application can be achieved. For example, the structure of the electrode assembly is a stacked structure or a wound structure. The electrode assembly includes a positive electrode plate, a negative electrode plate, and a separator, and the separator is disposed between the positive electrode plate and the negative electrode plate. The separator is used to separate the positive electrode plate from the negative electrode plate to prevent internal short circuit of the secondary battery and allows electrolyte ions to pass through freely without affecting the electrochemical charge-discharge process.

The positive electrode plate is not particularly limited in this application, provided that the objectives of this application can be achieved. For example, the positive electrode plate includes a positive electrode current collector and a positive electrode material layer disposed on at least one surface of the positive electrode current collector. The positive electrode current collector is not particularly limited in this application, provided that the objectives of this application can be achieved. For example, the positive electrode current collector may include aluminum foil, aluminum alloy foil, or the like. The positive electrode material layer in this application includes a positive electrode active material. The type of the positive electrode active material is not particularly limited in this application, provided that the objectives of this application can be achieved. For example, the positive electrode active material may include at least one of lithium nickel cobalt manganate (NCM811, NCM622, NCM523, NCM111), lithium nickel cobalt aluminate, lithium iron phosphate, lithium-rich manganese-based material, lithium cobaltate (LiCoO₂), lithium manganate, lithium iron manganese phosphate, lithium titanate, or the like. Thicknesses of the positive electrode current collector and the positive electrode material layer are not particularly limited in this application, provided that the objective of this application can be achieved. For example, the thickness of the positive electrode current collector is 4 μm to 20 μm. The thickness of the positive electrode material layer on one surface is 30 μm to 120 μm. In this application, the positive electrode material layer may be disposed on one or two surfaces of the positive electrode current collector in thickness direction. It should be noted that the “surface” herein may be the entire region or a partial region of the positive electrode current collector. This is not particularly limited in this application, provided that the objectives of this application can be achieved. The positive electrode material layer of this application may further include a positive electrode conductive agent and a positive electrode binder. The positive electrode conductive agent and the positive electrode binder are not particularly limited, provided that the objectives of this application can be achieved. For example, the positive electrode conductive agent may include at least one of conductive carbon black (Super P), carbon nanotubes (CNTs), carbon nanofibers, flake graphite, carbon dots, graphene, or the like. The positive electrode binder may include at least one of polyacrylic alcohol, sodium polyacrylate, potassium polyacrylate, lithium polyacrylate, polyimide, polyamideimide, styrene-butadiene rubber (SBR), polyvinyl alcohol (PVA), polyvinylidene difluoride (PVDF), polytetrafluoroethylene (PTFE), polyvinyl butyral (PVB), water-based acrylic resin, carboxymethyl cellulose lithium (CMC-Li), carboxymethyl cellulose sodium (CMC-Na), or the like.

The negative electrode plate is not particularly limited in this application, provided that the objectives of this application can be achieved. For example, the negative electrode plate includes a negative electrode current collector and a positive negative electrode material layer disposed on at least one surface of the negative electrode current collector. The negative electrode current collector is not particularly limited in this application, provided that the objectives of this application can be achieved. For example, the negative electrode current collector may include copper foil, copper alloy foil, nickel foil, stainless steel foil, titanium foil, nickel foam, copper foam, or the like. The negative electrode material layer of this application includes a negative electrode active material. The type of the negative electrode active material is not particularly limited in this application, provided that the objectives of this application can be achieved. For example, the negative electrode active material may include at least one of natural graphite, artificial graphite, mesocarbon microbead (MCMB), hard carbon, soft carbon, silicon, a silicon-carbon composite, SiOₓ (0<x≤2), a Li-Sn alloy, a Li-Sn-O alloy, Sn, SnO, SnO₂, spinel-structure lithium titanate Li₄Ti₅O₁₂, a Li-Al alloy, or a lithium metal. Thicknesses of the negative electrode current collector and the negative electrode material layer are not particularly limited in this application, provided that the objectives of this application can be achieved. For example, the thickness of the negative electrode current collector is 4 μm to 10 μm, and the thickness of the negative electrode material layer is 30 μm to 130 μm. In this application, the negative electrode material layer may be disposed on one or two surfaces of the negative electrode current collector in thickness direction. It should be noted that the “surface” herein may be the entire region or a partial region of the negative electrode current collector. This is not particularly limited in this application, provided that the objectives of this application can be achieved. Optionally, the negative electrode material layer may further include a negative electrode conductive agent and a negative electrode binder. The types of the negative electrode conductive agent and negative electrode binder in the negative electrode material layer are not particularly limited in this application, provided that the objectives of this application can be achieved. For example, the negative electrode conductive agent in the negative electrode material layer of this application may be the same as the positive electrode conductive agent, and the negative electrode binder may be the same as the positive electrode binder. The mass ratio of the negative electrode active material, negative electrode conductive agent, and negative electrode binder in the negative electrode material layer is not particularly limited in this application, provided that the objectives of this application can be achieved.

The separator is not particularly limited in this application, provided that the objectives of this application can be achieved. For example, a material of the separator may include but is not limited to at least one of a polyethylene (PE), polypropylene (PP), or polytetrafluoroethylene-based polyolefin (PO) separator, a polyester film (for example, a polyethylene terephthalate (PET) film), a cellulose film, a polyimide (PI) film, a polyamide (PA) film, a spandex, or an aramid film. The type of the separator may include but is not limited to at least one of a woven film, a non-woven film (non-woven fabric), a microporous film, a composite film, a laminated film, or a spinning film. The separator of this application may have a porous structure with a porous layer disposed on at least one surface of the separator. The porous layer includes inorganic particles and a binder, where the inorganic particles may include at least one of aluminum oxide, silicon oxide, magnesium oxide, titanium oxide, hafnium dioxide, tin oxide, cerium dioxide, nickel oxide, zinc oxide, calcium oxide, zirconium oxide, yttrium oxide, silicon carbide, boehmite, aluminum hydroxide, magnesium hydroxide, calcium hydroxide or barium sulfate. The binder may include at least one of polyvinylidene difluoride, a vinylidene fluoride-hexafluoropropylene copolymer, polyamide, polyacrylonitrile, polyacrylic acid, polyacrylate, polyacrylate, carboxymethyl cellulose sodium, polyvinylpyrrolidone, polyvinyl ether, polymethyl methacrylate, polytetrafluoroethylene, or polyhexafluoropropylene. The pore size of the porous structure is not particularly limited this application, provided that the objectives of this application can be achieved. For example, the pore size may be 0.01 μm to 1 μm. The thickness of the separator is not particularly limited in this application, provided that the objectives of this application can be achieved. For example, the thickness may be 5 μm to 500 μm.

The secondary battery of this application further includes a packaging bag, and the packaging bag is not particularly limited in this application, provided that the objectives of this application can be achieved. For example, an aluminum-plastic film packaging bag can be used. The secondary battery of this application further includes a double-sided tape affixed on the second surface of the electrode assembly for adhering to the electrode assembly and the packaging bag, and the double-sided tape is not particularly limited in this application, provided that the objectives of this application can be achieved.

The type of the secondary battery is not particularly limited in this application and may include any apparatus in which electrochemical reactions take place. For example, the secondary battery may include but is not limited to a lithium metal secondary battery, a lithium-ion battery, a sodium-ion battery, a lithium polymer secondary battery, or a lithium-ion polymer secondary battery. The shape of the secondary battery is not particularly limited in this application, provided that the objectives of this application can be achieved.

A process for preparation of secondary battery is well known to persons skilled in the art, and is not particularly limited in this application. For example, the process may include but is not limited to the following steps: stacking a positive electrode plate, a separator, and a negative electrode plate in sequence, performing tab welding and tab adhesive application, then performing operations such as winding and folding on the stack as needed to obtain an electrode assembly with a wound structure, applying a terminating adhesive to the terminating end of the wound structure, affixing an adhesive member between a positive electrode tab and a negative electrode tab and to a first surface of the electrode assembly, placing the electrode assembly to a packaging bag, and injecting an electrolyte into the packaging bag and sealing the packaging bag to obtain a secondary battery; or stacking a positive electrode plate, a separator, and a negative electrode plate in sequence, performing tab welding and tab adhesive application, fixing four corners of the entire stacked structure with tapes to obtain an electrode assembly with a stacked structure, affixing an adhesive member between a positive electrode tab and a negative electrode tab to a first surface of the electrode assembly, placing the electrode assembly into a packaging bag, injecting an electrolyte into the packaging bag and sealing the packaging bag to obtain a secondary battery. In addition, an overcurrent protection element, a guide plate, and the like may be placed as required in the packaging bag to prevent pressure increase, overcharge, and overdischarge in the secondary battery.

A second aspect of this application provides an electronic apparatus including the secondary battery according to the first aspect of this application. The secondary battery provided in the first aspect of this application has good safety performance and cycling performance, so that the electronic apparatus provided in the second aspect of this application has long service life.

The type of the electronic apparatus is not particularly limited in this application, and the electronic apparatus may be any known electronic apparatus used in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, or a lithium-ion capacitor.

### EXAMPLES

In the following, examples and comparative examples are given to describe some embodiments of this application in more detail. Various tests and evaluations are performed in the following methods. In addition, unless otherwise specified, “part” and “%” are based on mass.

### Test Methods and Devices

### Melting Point Test

After a lithium-ion battery was discharged to 3V and disassembling, the tab adhesive affixed to the surface of the positive electrode plate or negative electrode plate was taken, cleaned, and dried at 80° C. to obtain a tab adhesive sample. The tab adhesive sample was tested for its DSC curve using a differential scanning calorimeter (DSC), model DSC214, provided by NETZSCH Germany. An aluminum crucible was used for the test, a sample weight was 1 mg, the test temperature range was set to 60° C. to 200° C., and a heating rate was 10° C./min.

The tab adhesive sample taken using the foregoing method was soaked in dichloromethane at room temperature for 24 hours, so that the first adhesive layer, second adhesive layer, and third adhesive layer was separated and then dried at room temperature, and the differential scanning calorimeter was used to test the first adhesive layer, second adhesive layer, and third adhesive layer for the DSC curve separately. The DSC curves were analyzed to obtain a melting point T₁ of the first adhesive layer, a melting point T₂ of the second adhesive layer, and a melting point T₃ of the third adhesive layer.

### Hot Box Test

Lithium-ion batteries of each example and comparative example, were left standing for 60 minutes at 25° C., then placed in a thermostatic chamber. The temperature of the thermostatic chamber was risen to 132° C. at a temperature increase rate of 5° C.±2° C. and kept for 60 minutes, and the lithium-ion batteries were observed. The criteria for passing the hot box test are: no fire, no explosion. Hot box test pass rate=(number of lithium-ion batteries passing hot box test/n)×100%, where n is the number of lithium-ion batteries tested for each example or comparative example, and n=100.

### Cycling Performance Test

The lithium-ion battery was left standing for 30 minutes in a 25° C. environment, then charged and discharged according to the following steps: charged to 4.25 V at a constant current of 1.5 C, charged to 4.5 V at a constant current of 1.2 C, charged to 4.53 V at a constant current of 0.8 C, then constant-voltage charged to 0.14 C, left standing for 5 minutes, charged to 4.5 V at a constant current of 0.8 C, then constant-voltage charged to 0.05 C, left standing for 5 minutes, discharged to 3 V at a constant current of 1 C, and left standing for 5 minutes. This was one cycle. An initial discharge capacity C₀ of the lithium-ion battery was recorded. The cycle steps were repeated for 300 cycles, and a discharge capacity C₁ of the lithium-ion battery after 300 cycles was measured. During the cycling test, the lithium-ion battery was observed for any phenomena such as smoking, fire, or explosion. Capacity retention rate=C₁/C₀×100%. For each example and comparative example, statistics about 10 lithium-ion batteries were made, and an average value was calculated according to the foregoing test process to obtain the cycle capacity retention rate.

After 300 cycles, the lithium-ion batteries were disassembled and observed for lithium precipitation on the surface of the negative electrode plate. A region on the surface of the negative electrode plate without lithium precipitation appears golden yellow, while a region on the surface of the negative electrode plate with lithium precipitation appears grayish white. For each example and comparative example, statistics about lithium precipitation on the surface of the negative electrode plates of 10 lithium-ion batteries were made, and an average value was calculated to obtain a percentage of the lithium precipitation area used to evaluate the lithium precipitation state of the negative electrode plate. The percentage of lithium precipitation area was calculated based on a total single side area of the negative electrode material layer. The criteria for determining the lithium precipitation state on the surface of the negative electrode plate were as follows: no lithium precipitation when lithium precipitation area is less than or equal to 1%, slight lithium precipitation when lithium precipitation area is less than or equal to 3%, moderate lithium precipitation when lithium precipitation area is between 3% and 5%, and severe lithium precipitation when lithium precipitation area is greater than 5%.

### High-Temperature External Short Circuit Test

The lithium-ion battery was charged to 4.25 V at a constant current of 1.5 C, then charged to 4.5 V at a constant current of 1.2 C, then charged to 4.53 V at a constant current of 0.8 C, then constant-voltage charged to 0.14 C, left standing for 5 minutes, charged to 4.5 V at a constant current of 0.8 C, then constant-voltage charged to 0.05C, then placed in a 57° C.±4° C. environment. After the battery surface temperature reached 57° C.±4° C., the lithium-ion battery was left standing for 30 minutes. Then, in this environment temperature, positive and negative terminals of the battery were connected with a wire, and it should be ensured that a total external resistance is 80 m2. During the test, temperature changes of the lithium-ion battery were monitored. The test will be terminated when one of the following two conditions occurs: (a) the temperature drop of the battery reaches 20% of the maximum temperature; and (b) the short-circuit time reaches 24 hours. In case of a dispute, the stricter condition between (a) and (b) is selected. The criteria for passing the external short circuit test for the lithium-ion battery are: no fire, no explosion. High-temperature external short circuit test pass rate=(number of lithium-ion batteries passing the high-temperature external short circuit test/m)×100%, where m is the number of lithium-ion batteries tested for each example or comparative example, and m=100.

### Example 1-1

### <Preparation of Tab Adhesive>

The tab adhesive was composed of a first adhesive layer, a second adhesive layer, and a third adhesive layer stacked sequentially. The material used for the first and third adhesive layers was the first polypropylene with a melting point of 123.1° C. and a weight-average molecular weight Mw₁ of 1500; and the material of the second adhesive layer was the second polypropylene with a melting point of 160° C. and a weight-average molecular weight Mw₂ of 4500. The thickness Hₐ of the first adhesive layer, the thickness H_{b} of the second adhesive layer, and the thickness H_{c} of the third adhesive layer are shown in Table 4.

### <Preparation of Positive Electrode Plate>

Positive electrode active material lithium cobaltate (LiCoO₂), positive electrode conductive agent conductive carbon black (Super P), and positive electrode binder polyvinylidene difluoride (PVDF) were mixed at a mass ratio of 97.5:1:1.5, added with N-methylpyrrolidone (NMP) as a solvent, and stirred to uniformity to obtain a positive electrode slurry with a solid content of 75 wt %. The positive electrode slurry was uniformly applied onto one surface of a positive electrode current collector aluminum foil with a thickness of 10 μm and dried at 85° C. to obtain a positive electrode plate with a positive electrode material layer of 110 μm in thickness coated on one surface. The foregoing steps were repeated on another surface of the aluminum foil to obtain a positive electrode plate with the positive electrode material layer coated on two surfaces. Then, the positive electrode plate was cold-pressed, cut, and welded with a positive electrode tab aluminum tab to obtain a positive electrode plate with specifications of 75 mm×870 mm for later use. The tab adhesive prepared was affixed to the positive electrode tab, the dimensions of the positive electrode tab were 5 mm×40 mm×90 μm (direction X×direction Y×direction Z), and the dimensions of the tab adhesive are 8.6 mm×10 mm×150 μm (direction X×direction Y×direction Z). As shown in FIG. 4, widths of the tab adhesive extending beyond two sides of the positive electrode tab are M₁ mm and M₂ mm respectively, where M₁=1.8 and M₂=1.8.

### <Preparation of Negative Electrode Plate>

Negative electrode active material graphite, negative electrode conductive agent Super P, and negative electrode binder styrene-butadiene rubber (SBR) were mixed at a mass ratio of 96:1.5:2.5, then added with deionized water as a solvent, and stirred to uniformity to obtain a negative electrode slurry with a solid content of 70 wt %. The negative electrode slurry was uniformly applied onto one surface of a negative electrode current collector aluminum copper foil with a thickness of 5 μm and dried at 85° C. to obtain a negative electrode plate with a negative electrode material layer of 130 μm in thickness coated on one surface. The foregoing steps were repeated on another surface of the copper foil to obtain a negative electrode plate coated with the negative electrode material layer on two surfaces. Then, the negative electrode plate was cold-pressed, cut, and welded with a negative electrode tab nickel tab to obtain a negative electrode plate with specifications of 78 mm×880 mm for later use. The tab adhesive prepared was affixed to the negative electrode tab, the dimensions of the negative electrode were 5 mm×40 mm×90 μm (direction X×direction Y×direction Z), and the dimensions of the tab adhesive are 8.6 mm×10 mm×150 μm (direction X×direction Y×direction Z). As shown in FIG. 4, widths of the tab adhesive extending beyond two sides of the negative electrode tab are M₃ mm and M₄ mm respectively, where M₃=1.8 and M₄=1.8.

### <Preparation of Electrolyte>

In an argon atmosphere glove box with water content less than 10 ppm, ethyl propionate, propyl propionate, fluoroethylene carbonate, and ethylene carbonate were mixed to obtain a basis solvent, then added with lithium salt lithium hexafluorophosphate (LiPF₆) and mixed to uniformity to obtain an electrolyte. Based on a mass of the electrolyte, a mass percentage of ethyl propionate was 30%, a mass percentage of propyl propionate was 35%, a mass percentage of ethylene carbonate was 20%, and a mass percentage of fluoroethylene carbonate was 3%, and a mass percentage of the lithium salt was 12%.

### <Preparation of Separator>

PVDF and aluminum oxide ceramics were mixed at a mass ratio of 9:1, added with deionized water as a solvent to prepare a ceramic layer slurry with a solid content of 25 wt %. The slurry was stirred to uniformity, uniformly applied onto one surface of a polyethylene porous film substrate of 5 μm in thickness, and dried to obtain a separator with an aluminum oxide ceramic layer of 2 μm coated on one surface. The foregoing coating steps were repeated on another surface of the substrate to obtain a separator with the aluminum oxide ceramic layer of 2 μm coated on two surfaces.

### <Preparation of Adhesive Member>

Material polyacrylic acid (PAA, with a weight-average molecular weight of 2000) for the first adhesive layer was applied onto one surface of a polyethylene terephthalate (PET) film substrate layer of 8 mm and dried at 80° C. to form a first adhesive layer with a thickness of 4 mm. Then, material styrene-isoprene-styrene block copolymer (SIS, with a weight-average molecular weight of 4000) for the second adhesive layer was applied onto another surface of the substrate layer and dried at 80° C. to form a second adhesive layer with a thickness of 4 mm, and an adhesive member was obtained.

### <Preparation of Double-Sided Tape>

Styrene-isoprene-styrene block copolymer was heated to 150° C. and melted, then applied onto one surface of a second substrate layer polyethylene terephthalate (PET) film of 8 mm in thickness, and dried at 120° C. to form a third adhesive layer with a thickness of 8 mm. Polyacrylic acid (PAA) was applied onto another surface of the second substrate layer and dried at 80° C. to form a fourth adhesive layer with a thickness of 4 mm, and a double-sided tape containing the third adhesive layer, the second substrate layer, and the fourth adhesive layer stacked sequentially was obtained.

### <Preparation of Lithium-Ion Battery>

The prepared positive electrode plate, separator, and negative electrode plate were stacked in sequence, with the separator being between the positive electrode plate and the negative electrode plate for separation. Then, winding was performed to obtain an electrode assembly with a wound structure, and the adhesive member prepared was affixed between a positive electrode tab and a negative electrode tab and to a first surface through the first adhesive layer, meaning that the position for the adhesive member was between the two tabs. Then double-sided tape was affixed to a second surface of the electrode assembly. The double-sided tape was affixed to the electrode assembly through the fourth adhesive layer. The electrode assembly was placed into an aluminum-plastic film packaging bag, followed by processes such as top-side sealing, vacuum drying, electrolyte injection, formation (at a temperature of 85° C., a pressure of 1.05 MPa, and 3.5 V), capacity grading, and vacuum pumping, to obtain a lithium-ion battery. In the process of formation, the third adhesive layer of the double-sided tape was adhered to the packaging bag. The lithium-ion battery was 45 g in mass, with a liquid retention coefficient of 1.6 g/Ah. In the direction Z, the dimension of the electrode assembly is E mm, A=75, B=50, E=5. The width C and length D of the adhesive member, the shoulder width M of the tab adhesive, and the distance N between the tab adhesive and the adhesive member are shown in Table 2, and the thickness H₂ of the tab adhesive is shown in Table 4.

### Examples 1-2 to 1-7

These examples were the same as Example 1-1 except that the parameters were adjusted according to Table 1.

### Examples 2-1 to 2-10

These examples were the same as Example 1-1 except that the parameters were adjusted according to Table 2.

### Examples 3-1 to 3-7

These examples were the same as Example 1-1 except that the mass percentages of ethyl propionate, propyl propionate, ethylene carbonate, and fluoroethylene carbonate in the electrolyte were adjusted according to Table 3, and that the percentage of the lithium salt remained unchanged.

### Examples 4-1 and 4-2

These examples were the same as Example 1-1 except that the thickness of the tab adhesive was adjusted according to Table 4.

### Comparative Example 1

This comparative example was the same as Example 1-1 except that no adhesive member was disposed between the positive electrode tab and the negative electrode tab (referred to as no adhesive member).

### Comparative Example 2

This comparative example was the same as Example 1-1 except that the adhesive member was affixed to the outer sides of the positive electrode tab and the negative electrode tab. As shown in FIG. 6, positions for the adhesive member were shown to be outer side of the two tabs.

### Comparative Example 3

This comparative example was the same as Example 1-1 except that a single-sided adhesive member prepared according to the following steps was affixed between the positive electrode tab and the negative electrode tab.

### <Preparation of Single-Sided Adhesive Member>

Material polyacrylic acid (PAA, with a weight-average molecular weight of 2000) for the first adhesive layer was applied onto one surface of a polyethylene terephthalate (PET) film substrate layer of 8 mm and dried at 80° C. to form a first adhesive layer with a thickness of 4 mm, and a single-sided adhesive member was obtained.

### Comparative Examples 4 to 7

These comparative examples were the same as Example 1-1 except that the parameters were adjusted according to Table 1.

The relevant parameters and performance tests of each example and comparative example are shown in Tables 1 to 4.

TABLE 1

| | | | | | | | | High- | | | |
|---|---|---|---|---|---|---|---|---|---|---|---|
| | | | | | | | | temperature | Hot | | |
| | Position | | | | | | Material | external | box | | |
| | for | | | | | Material | for | short | test | Cycle | |
| | affixing | | | | | for first | second | circuit test | pass | capacity | Lithium |
| | adhesive | H1 | T | T₂ | | adhesive | adhesive | pass rate | rate | retention | precipitation |
| | member | (μm) | (° C.) | (° C.) | M_{w2} | layer | layer | (%) | (%) | rate (%) | area (%) |
| Example 1-1 | Between | 90 | 160 | 160 | 4500 | PAA | SIS | 100 | 93 | 95 | 0 |
| | two tabs | | | | | | | | | | |
| Example 1-2 | Between | 80 | 160 | 160 | 3500 | PAA | SIS | 100 | 89 | 94 | 0 |
| | two tabs | | | | | | | | | | |
| Example 1-3 | Between | 100 | 160 | 160 | 3500 | PAA | SIS | 100 | 90 | 93 | 0 |
| | two tabs | | | | | | | | | | |
| Example 1-4 | Between | 90 | 135 | 135 | 3000 | PAA | SIS | 100 | 92 | 94 | 0 |
| | two tabs | | | | | | | | | | |
| Example 1-5 | Between | 90 | 142.6 | 142.6 | 3500 | PAA | SIS | 100 | 90 | 94 | 0 |
| | two tabs | | | | | | | | | | |
| Example 1-5 | Between | 90 | 165 | 165 | 4700 | PAA | SIS | 100 | 92 | 93 | 0 |
| | two tabs | | | | | | | | | | |
| Example 1-6 | Between | 90 | 160 | 160 | 3500 | PE | PI | 100 | 92 | 95 | 0 |
| | two tabs | | | | | | | | | | |
| Example 1-7 | Between | 90 | 160 | 160 | 3500 | PA | PMMA | 100 | 93 | 94 | 0 |
| | two tabs | | | | | | | | | | |
| Comparative | No | 90 | 160 | 160 | 3500 | / | / | 100 | 65 | 76 | 8 |
| example 1 | adhesive | | | | | | | | | | |
| | member | | | | | | | | | | |
| Comparative | Outer | 90 | 160 | 160 | 3500 | PAA | SIS | 100 | 71 | 77 | 4 |
| example 2 | side of | | | | | | | | | | |
| | two tabs | | | | | | | | | | |
| Comparative | Between | 90 | 160 | 160 | 3500 | PAA | / | 100 | 67 | 75 | 2 |
| example 3 | two tabs | | | | | | | | | | |
| Comparative | Between | 60 | 160 | 160 | 3500 | PAA | SIS | 82 | 70 | 77 | 6 |
| example 4 | two tabs | | | | | | | | | | |
| Comparative | Between | 120 | 160 | 160 | 3500 | PAA | SIS | 97 | 73 | 75 | 4 |
| example 5 | two tabs | | | | | | | | | | |
| Comparative | Between | 90 | 130 | 130 | 2500 | PAA | SIS | 96 | 75 | 78 | 4 |
| example 6 | two tabs | | | | | | | | | | |
| Comparative | Between | 90 | 170 | 170 | 5500 | PAA | SIS | 100 | 73 | 76 | 5 |
| example 7 | two tabs | | | | | | | | | | |

Note:
In Table 1, “/” indicates that the corresponding substance does not exist.

From Examples 1-1 to 1-7 and Comparative examples 1 to 7, it can be seen that with the adhesive member being disposed between the positive electrode tab and the negative electrode tab and the values of H₁ and T being controlled within the ranges in this application, the lithium-ion battery can have a higher high-temperature external short circuit test pass rate, hot box test pass rate, and cycle capacity retention rate, and there is no lithium precipitation on the negative electrode plate, indicating that the lithium-ion battery has better safety performance and cycling performance, and that the lithium precipitation problem of the negative electrode plate is alleviated. In Comparative example 1, no adhesive member is disposed; in Comparative example 2, the adhesive member is disposed outside the positive electrode tab and the negative electrode tab; in Comparative example 3, the adhesive member does not include the second adhesive layer and is different from the adhesive member of this application; and in Comparative examples 4 to 7, at least one of the values of H₁ or T is not within the range in this application. The lithium-ion batteries of these comparative examples have lower high-temperature external short circuit test pass rates, hot box test pass rates, and cycle capacity retention rates, and lithium precipitation occurs on the negative electrode plate, indicating that the lithium-ion batteries have poor safety performance and cycling performance.

The value of H₁ usually affects the safety performance and cycling performance of the lithium-ion battery. From Examples 1-1 to 1-3 and Comparative examples 4 and 5, it can be seen that when the value of H₁ is too small, for example, in Comparative example 4, the lithium-ion battery has lower high-temperature external short circuit test pass rate, hot box test pass rate, and cycle capacity retention rate, and there is severe lithium precipitation on the negative electrode plate. When the value of H₁ is too large, for example, in Comparative example 5, the lithium-ion battery has lower high-temperature external short circuit test pass rate, hot box test pass rate, and cycle capacity retention rate, and there is moderate lithium precipitation on the negative electrode plate, indicating that when the value of H₁ is not within the range in this application, the lithium-ion battery has poor safety performance and cycling performance. Therefore, with the value of H₁ being controlled within the range in this application, the lithium-ion battery has a higher hot box test pass rate and cycle capacity retention rate, and the interface problem and lithium precipitation problem of the lithium-ion battery are alleviated, indicating that the lithium-ion battery has better safety performance and cycling performance.

The value of T usually affects the safety performance and cycling performance of the lithium-ion battery. From Example 1-1, Examples 1-4 and 1-5, and Comparative examples 6 and 7, it can be seen that when the value of T is too small, for example, in Comparative example 6, the lithium-ion battery has lower high-temperature external short circuit test pass rate, hot box test pass rate, and cycle capacity retention rate, and there is moderate lithium precipitation on the negative electrode plate. When the value of T is too large, for example, in Comparative example 7, the lithium-ion battery has lower high-temperature external short circuit test pass rate, hot box test pass rate, and cycle capacity retention rate, and there is moderate lithium precipitation on the negative electrode plate, indicating that when the value of T is not within the range in this application, the lithium-ion battery has poor safety performance and cycling performance. Therefore, with the value of T being controlled within the range in this application, the lithium-ion battery has a higher high-temperature external short circuit test pass rate, hot box test pass rate, and cycle capacity retention rate, and there is no lithium precipitation on the negative electrode plate, indicating that the lithium-ion battery has better safety performance and cycling performance, and the lithium precipitation problem of the negative electrode plate is alleviated.

The types of materials used for the first adhesive layer and the second adhesive layer usually affect the safety performance and cycling performance of the lithium-ion battery. From Example 1-1 and Examples 1-6 and 1-7, it can be seen that with the use of the materials for the first adhesive layer and the second adhesive layer within the ranges in this application, the lithium-ion batteries have a higher high-temperature external short circuit test pass rate, hot box test pass rate, and cycle capacity retention rate, and there is no lithium precipitation on the negative electrode plate, indicating that the lithium-ion batteries have good safety performance and cycling performance, and there is no lithium precipitation problem on the negative electrode plate.

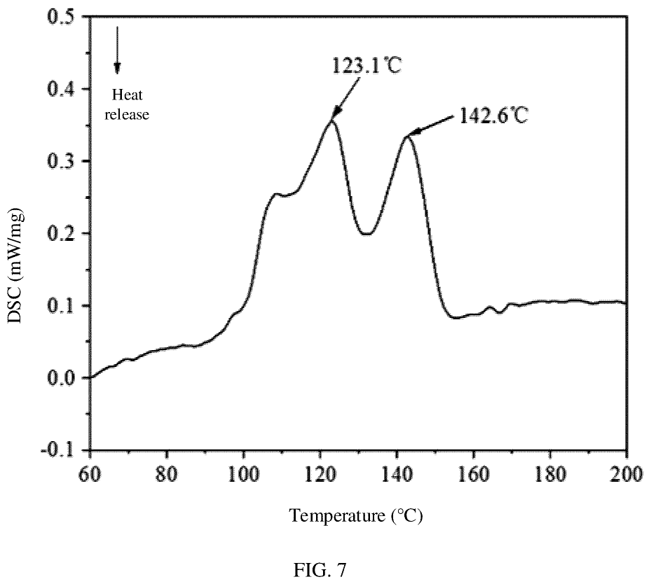

FIG. 7 shows a DSC curve of the tab adhesive in Example 1-5. It can be seen that the curve includes an endothermic peak at a temperature of T=142.6° C., and that the DSC curve of the tab adhesive in Example 1-5 further includes an endothermic peak at a temperature of 123.1° C.

TABLE 2

| | | | | Satisfying | | | | | | | |
|---|---|---|---|---|---|---|---|---|---|---|---|
| | | | | 0.0014 × | | E + | | | | | |
| | | | | T × B ≤ | | 0.25 ≤ | | Satisfying | | | |
| | | C | C/ | C ≤ 0.004 × | D | D ≤ E + | L | 0.25 A ≤ | M | N | |
| | T | (mm) | (T × B) | T × B? | (mm) | 0.28 A? | (mm) | L ≤ 0.28 A? | (mm) | (mm) | N/M |
| Example | 160 | 15 | 0.0019 | Yes | 23.8 | Yes | 18.8 | Yes | 1.8 | 0.5 | 0.28 |
| 1-1 | | | | | | | | | | | |
| Example | 135 | 15 | 0.0022 | Yes | 23.8 | Yes | 18.8 | Yes | 1.8 | 0.5 | 0.28 |
| 1-4 | | | | | | | | | | | |
| Example | 165 | 15 | 0.0018 | Yes | 23.8 | Yes | 18.8 | Yes | 1.8 | 0.5 | 0.28 |
| 1-6 | | | | | | | | | | | |
| Example | 160 | 16 | 0.002 | Yes | 23.8 | Yes | 18.8 | Yes | 1.7 | 0.48 | 0.28 |
| 2-1 | | | | | | | | | | | |
| Example | 160 | 24 | 0.003 | Yes | 23.8 | Yes | 18.8 | Yes | 1.5 | 0.46 | 0.31 |
| 2-2 | | | | | | | | | | | |
| Example | 160 | 32 | 0.004 | Yes | 23.8 | Yes | 18.8 | Yes | 1.3 | 0.44 | 0.34 |
| 2-3 | | | | | | | | | | | |
| Example | 160 | 8 | 0.001 | No | 23.8 | Yes | 18.8 | Yes | 2.2 | 0.9 | 0.41 |
| 2-4 | | | | | | | | | | | |
| Example | 160 | 15 | 0.0019 | Yes | 26.2 | Yes | 21.2 | Yes | 1.8 | 0.5 | 0.28 |
| 2-5 | | | | | | | | | | | |
| Example | 160 | 15 | 0.0019 | Yes | 5 | No | 0 | No | 1.8 | 0.5 | 0.28 |
| 2-6 | | | | | | | | | | | |
| Example | 160 | 15 | 0.0019 | Yes | 23.8 | Yes | 18.8 | Yes | 2.3 | 0.58 | 0.25 |
| 2-7 | | | | | | | | | | | |
| Example | 160 | 15 | 0.0019 | Yes | 23.8 | Yes | 18.8 | Yes | 1.2 | 0.6 | 0.5 |
| 2-8 | | | | | | | | | | | |
| Example | 160 | 15 | 0.0019 | Yes | 23.8 | Yes | 18.8 | Yes | 1 | 2 | 2 |
| 2-9 | | | | | | | | | | | |
| Example | 160 | 15 | 0.0019 | Yes | 23.8 | Yes | 18.8 | Yes | 2.5 | 0.3 | 0.12 |
| 2-10 | | | | | | | | | | | |

| | | High- | | | |
|---|---|---|---|---|---|
| | | temperature | Hot | | |
| | | external | box | Cycle | |
| | | short | test | capacity | Lithium |
| | Satisfying | circuit | pass | retention | precipitation |
| | 0.25M ≤ | test pass | rate | rate | area |
| | N ≤ 0.5M? | rate (%) | (%) | (%) | (%) |
| Example | Yes | 100 | 93 | 95 | 0 |
| 1-1 | | | | | |
| Example | Yes | 100 | 90 | 92 | 0 |
| 1-4 | | | | | |
| Example | Yes | 100 | 92 | 93 | 0 |
| 1-6 | | | | | |
| Example | Yes | 100 | 92 | 91 | 0 |
| 2-1 | | | | | |
| Example | Yes | 100 | 91 | 92 | 0 |
| 2-2 | | | | | |
| Example | Yes | 100 | 87 | 89 | 0 |
| 2-3 | | | | | |
| Example | Yes | 100 | 77 | 78 | 2 |
| 2-4 | | | | | |
| Example | Yes | 100 | 91 | 89 | 0 |
| 2-5 | | | | | |
| Example | Yes | 100 | 77 | 79 | 3 |
| 2-6 | | | | | |
| Example | Yes | 100 | 90 | 92 | 0 |
| 2-7 | | | | | |
| Example | Yes | 100 | 92 | 93 | 0 |
| 2-8 | | | | | |
| Example | No | 100 | 78 | 78 | 2 |
| 2-9 | | | | | |
| Example | No | 100 | 75 | 79 | 4 |
| 2-10 | | | | | |

The relationship among T, B, and C usually affects the safety performance and cycling performance of the lithium-ion battery. From Example 1-1, Example 1-4, Example 1-6, and Examples 2-1 to 2-4, it can be seen that when the relationship among T, B, and C satisfies 0.0014×T×B≤C≤0.004×T×B, the lithium-ion batteries have a higher high-temperature external short circuit test pass rate, hot box test pass rate, and cycle capacity retention rate, and the lithium precipitation area on the negative electrode plates is small, indicating that the lithium-ion batteries have good safety performance and cycling performance, and the lithium precipitation problem of the negative electrode plate is alleviated.

The relationship among E, A, and D usually affects the safety performance and cycling performance of the lithium-ion battery. From Example 1-1 and Examples 2-5 and 2-6, it can be seen that when the relationship among E, A, and D satisfies E+0.25 A≤D≤E+0.28 A, the lithium-ion batteries have a higher high-temperature external short circuit test pass rate, hot box test pass rate, and cycle capacity retention rate, and the lithium precipitation area on the negative electrode plates is small, indicating that the lithium-ion batteries have good safety performance and cycling performance, and the lithium precipitation problem of the negative electrode plate is alleviated.

The relationship between L and A usually affects the safety performance and cycling performance of the lithium-ion battery. From Example 1-1 and Examples 2-5 and 2-6, it can be seen that when the relationship between L and A satisfies 0.25 A≤L≤0.28 A, the lithium-ion batteries have a higher high-temperature external short circuit test pass rate, hot box test pass rate, and cycle capacity retention rate, and the lithium precipitation area on the negative electrode plates is small, indicating that the lithium-ion batteries have good safety performance and cycling performance, and the lithium precipitation problem of the negative electrode plate is alleviated.

The relationship between M and N usually affects the safety performance and cycling performance of the lithium-ion battery. From Example 1-1 and Examples 2-7 to 2-10, it can be seen that when the relationship between M and N satisfies 0.25M≤N≤0.5M, the lithium-ion batteries have a higher high-temperature external short circuit test pass rate, hot box test pass rate, and cycle capacity retention rate, and the lithium precipitation area on the negative electrode plates is small, indicating that the lithium-ion batteries have good safety performance and cycling performance, and the lithium precipitation problem of the negative electrode plate is alleviated.

The values of A, B, E, C, D, L, M, and N usually affect the safety performance and cycling performance of the lithium-ion battery. From Example 1-1 and Examples 2-1 to 2-10, it can be seen that with the foregoing parameters being controlled within the ranges in this application, the lithium-ion batteries have a higher high-temperature external short circuit test pass rate, hot box test pass rate, and cycle capacity retention rate, and the lithium precipitation area on the negative electrode plates is small, indicating that the lithium-ion batteries have good safety performance and cycling performance, and the lithium precipitation problem of the negative electrode plate is alleviated.

TABLE 3

| | Mass | Mass | Mass | Mass | | | |
|---|---|---|---|---|---|---|---|
| | percentage | percentage | percentages | percentage of | | Cycle | |
| | of ethyl | of propyl | of ethylene | fluoroethylene | Hot box | capacity | Lithium |
| | propionate | propionate | carbonate | carbonate | test pass | retention | precipitation |
| | (%) | (%) | (%) | (%) | rate (%) | rate (%) | area (%) |
| Example 1-1 | 30 | 35 | 20 | 3 | 93 | 95 | 0 |
| Example 3-1 | 35 | 25 | 25 | 3 | 91 | 92 | 0 |
| Example 3-2 | 10. | 40 | 35 | 3 | 90 | 94 | 0 |
| Example 3-3 | 35 | 14 | 36 | 3 | 86 | 90 | 0 |
| Example 3-4 | 39 | 40 | 6 | 3 | 83 | 91 | 0 |
| Example 3-5 | 8 | 42 | 35 | 3 | 88 | 93 | 0 |
| Example 3-6 | 30 | 35 | 21 | 2 | 93 | 94 | 0 |
| Example 3-7 | 30 | 35 | 18 | 5 | 93 | 92 | 0 |

Note:
In Table 3, “/” indicates that the corresponding parameter or substance does not exist.

The composition of the electrolyte usually affects the safety performance and cycling performance of the lithium-ion battery. From Example 1-1 and Examples 3-1 to 3-7, it can be seen that with the composition of the electrolyte being controlled within the ranges in this application, the lithium-ion batteries have a higher hot box test pass rate and cycle capacity retention rate, and there is no lithium precipitation on the negative electrode plate, indicating that the lithium-ion batteries have good safety performance and cycling performance, and there is no lithium precipitation problem on the negative electrode plate.

TABLE 4

| | | | | | High- | | | |
|---|---|---|---|---|---|---|---|---|
| | | | | | temperature | | | |
| | | | | | external | | Cycle | |
| | | | | | short circuit | Hot box | capacity | Status of |
| | H₂ | Hₐ | H_{b} | H_{c} | test pass | test pass | retention | lithium |
| | (μm) | (μm) | (μm) | (μm) | rate (%) | rate (%) | rate (%) | precipitation |
| Example 1-1 | 150 | 37.5 | 75 | 37.5 | 100 | 93 | 95 | 0 |
| Example 4-1 | 100 | 25 | 50 | 25 | 100 | 92 | 91 | 0 |
| Example 4-2 | 200 | 50 | 100 | 50 | 100 | 90 | 94 | 0 |

The value of the thickness H₂ of the tab adhesive usually affects the safety performance and cycling performance of the lithium-ion battery. From Example 1-1, Example 4-1, and Example 4-2, it can be seen that with the value of H₂ being controlled within the range in this application, the lithium-ion batteries have a higher high-temperature external short circuit test pass rate, hot box test pass rate, and cycle capacity retention rate, and there is no lithium precipitation on the negative electrode plate, indicating that the lithium-ion batteries have good safety performance and cycling performance, and the lithium precipitation problem of the negative electrode plate is alleviated.

It should be noted that relational terms such as “first” and “second” herein are only used to distinguish one entity or operation from another entity or operation, and do not necessarily require or imply that there is any such actual relationship or order between these entities or operations. In addition, the terms “include”, “comprise”, or any of their variants are intended to cover a non-exclusive inclusion, such that a process, method, or article that includes a series of elements includes not only those elements but also other elements that are not expressly listed, or further includes elements inherent to such process, method, or article.

Some embodiments in this specification are described in a related manner. For a part that is the same or similar between different embodiments, reference may be made between the embodiments. Each embodiment focuses on differences from other embodiments.

The foregoing descriptions are merely preferred embodiments of this application, and are not intended to limit this application. Any modifications, equivalent replacements, improvements, and the like made without departing from the spirit and principle of this application shall fall within the protection scope of this application.

What is claimed is:

1. A secondary battery, comprising a packaging bag, an electrode assembly, a tab, a tab adhesive, and an adhesive member; wherein the electrode assembly is accommodated within the packaging bag, the electrode assembly comprises a first surface, the tab protrudes from the electrode assembly through the first surface, the tab extends in a direction Y, a thickness direction of the tab is a direction Z, and a direction perpendicular to the direction Y and the direction Z is a direction X;
a thickness of the tab is H₁ μm, wherein 80≤H₁≤100, the tab is covered with the tab adhesive, the tab adhesive is adhered to the packaging bag, and a DSC curve of the tab adhesive has an endothermic peak at a temperature of T° C., wherein 135≤T≤165; and
the tab comprises a positive electrode tab and a negative electrode tab, the adhesive member is disposed between the positive electrode tab and the negative electrode tab in the direction X; the adhesive member comprises a first adhesive layer, a substrate layer, and a second adhesive layer stacked together; the first adhesive layer is adhered to the first surface, and the second adhesive layer is a thermosensitive adhesive layer.

2. The secondary battery according to claim 1, wherein in the direction X, a dimension of the electrode assembly is B mm; in the direction Y, a dimension of the electrode assembly is A mm; and in the direction Z, a dimension of the electrode assembly is E mm;
in the direction X, a width of the adhesive member is C mm, wherein 0.0014×T×B≤C≤0.004×T×B; and
in the direction Z, the electrode assembly comprises a second surface and a third surface opposite to each other, the adhesive member extends from the second surface to the third surface in an extension direction; and in the extension direction of the adhesive member from the second surface to the third surface, a sum of dimensions of the adhesive member affixed within the first surface, the second surface, and the third surface is a length of the adhesive member, and the length of the adhesive member is D mm, wherein E+0.25 A≤D≤E+0.28 A.

3. The secondary battery according to claim 2, wherein 70≤A≤100, 40≤B≤70, and 4≤E≤6.

4. The secondary battery according to claim 2, wherein in the extension direction of the adhesive member from the second surface to the third surface, a sum of dimensions of the adhesive member affixed within the second surface and the third surface is L mm, wherein 0.25 A≤L≤0.28 A.

5. The secondary battery according to claim 4, wherein 17.5≤L≤30.

6. The secondary battery according to claim 1, wherein in the direction X, a dimension of the tab adhesive extending beyond the tab is a shoulder width of the tab adhesive, the shoulder width of the tab adhesive is M mm; and in the direction X, a distance between the tab adhesive and the adhesive member is N mm, wherein 0.25M≤N≤0.5M.

7. The secondary battery according to claim 6, wherein 1.2≤M≤2.3.

8. The secondary battery according to claim 1, wherein a material of the first adhesive layer includes at least one of polyethylene oxide, acrylonitrile-styrene-butadiene copolymer, styrene-butadiene copolymer, polyvinyl alcohol, polyvinyl methyl ether, polyvinyl ethyl ether, polyvinylidene difluoride, polytetrafluoroethylene, polyhexafluoropropylene, polyacrylic acid, polymethyl methacrylate, polypropylene, polyethylene, or polyamide;
a material of the thermosensitive adhesive layer includes at least one of polymethyl methacrylate, polyacrylic acid, polyacrylate, polyacrylonitrile, polyvinylpyrrolidone, ethylene vinyl acetate copolymer, styrene-isoprene-styrene block copolymer, ethylene-vinyl acetate copolymer, or polyimide; and
a material of the substrate layer includes at least one of polyethylene, polypropylene, polyethylene terephthalate, or polyimide.

9. The secondary battery according to claim 1, wherein a thickness of the tab adhesive is H₂ μm, wherein 100≤H₂≤200.

10. The secondary battery according to claim 1, wherein the tab adhesive is on a surface of the tab and comprises a first adhesive layer, a second adhesive layer, and a third adhesive layer stacked together; a melting point of the first adhesive layer is T₁° C., a melting point of the second adhesive layer is T₂° C., and a melting point of the third adhesive layer is T₃° C., wherein 120≤T₁≤125,135≤T₂≤165, and 120≤T₃≤125.

11. The secondary battery according to claim 1, wherein a material of the tab adhesive includes at least one of polypropylene, polyethylene, polyethylene terephthalate, polyimide, or polyamide.

12. The secondary battery according to claim 1, wherein the packaging bag further comprises a sealing layer, the sealing layer is adhered to the tab adhesive, and a material of the sealing layer includes at least one of polypropylene or polyethylene.

13. The secondary battery according to claim 1, wherein the secondary battery further comprises an electrolyte; the electrolyte comprises ethyl propionate, propyl propionate, ethylene carbonate, and fluoroethylene carbonate; and based on a mass of the electrolyte, a mass percentage of the ethyl propionate is 8% to 35%, a mass percentage of the propyl propionate is 14% to 40%, a mass percentage of the ethylene carbonate is 6% to 35%, and a mass percentage of the fluoroethylene carbonate is 2% to 5%.

14. The secondary battery according to claim 10, wherein the first adhesive layer and the third adhesive layer each independently include a first polypropylene; and a weight-average molecular weight Mw₁ of the first polypropylene is 1000 to 2500.

15. The secondary battery according to claim 10, wherein the second adhesive layer includes a second polypropylene, and a weight-average molecular weight Mw₂ of the second polypropylene is 3000 to 5000.

16. The secondary battery according to claim 10, wherein a thickness of the first adhesive layer is Ha μm, a thickness of the second adhesive layer is Hb μm, a thickness of the third adhesive layer is Hc μm, and a ratio S of Ha, Hb and Hc is 1:(1.2-2):1.

17. An electronic apparatus, comprising the secondary battery according to claim 1.

18. The electronic apparatus according to claim 17, wherein in the direction X, a dimension of the electrode assembly is B mm, in the direction Y, a dimension of the electrode assembly is A mm, and in the direction Z, a dimension of the electrode assembly is E mm;
in the direction X, a width of the adhesive member is C mm, wherein 0.0014×T×B≤C≤0.004×T×B; and
in the direction Z, the electrode assembly comprises a second surface and a third surface opposite to each other, the adhesive member extends from the second surface to the third surface, and a sum of dimensions of the adhesive member affixed within the first surface, the second surface, and the third surface is a length of the adhesive member, and the length of the adhesive member is D mm, wherein E+0.25 A≤D≤E+0.28 A.

19. The electronic apparatus according to claim 18, wherein 70≤A≤100, 40≤B≤70, and 4≤E≤6.

20. The electronic apparatus according to claim 18, wherein a sum of dimensions of the adhesive member affixed within the second surface and the third surface is L mm, wherein 0.25 A≤L≤0.28 A.
